(19) United States
(12) Patent Application Publication
(10) Pub. No.: US 2006/0228008 A1
(43) Pub. Date: Oct. 12, 2006

(54) Method and apparatus for analyzing biological tissues

(75) Inventors: Nicola Dioguardi, Rozzano (Milano) (IT); Fabio Grizzi, Rozzano (Milano) (IT); Carlo Russo, Rozzano (Milano) (IT); Barbara Franceschini, Rozzano (Milano) (IT); Paolo Vinciguerra, Rozzano (Milano) (IT); Ingrid Torres-Munoz, Rozzano (Milano) (IT)

Correspondence Address: MERCHANT & GOULD PC, P.O. BOX 2903, MINNEAPOLIS, MN, 55402-0903, US

(73) Assignee: HUMANITAS MIRASOLE S.p.A., Rozzano (Milano) (IT)

(21) Appl. No.: 10/563,696

(22) PCT Filed: Jul. 9, 2003
(86) PCT No.: PCT/IB03/02703

§ 371 Date: Jun. 6, 2006

(51) Int. Cl. G06K 9/00

(52) U.S. Cl. 382/128

(57) ABSTRACT

The present invention relates to a method and an apparatus for processing images of irregularly shaped objects, such as biological specimens, in particular of human or animal origin, or images thereof. The metric quantification of a biological body part or tissue or of a material spot or aggregate of any origin which is contained therein is also performed by the present invention method. In particular, the method of the present invention is applied to the “confocal microscopy” technique. In particular, the present invention relates to a method of processing digital images including one or more objects to be quantified, the method including normalization of the digital images and quantization of the images to one bit. The method further including at least calculating, from the images quantized to one bit, the perimeter, area and/or fractal dimension of the one or more objects to be quantified and/or reconstructing, from the images quantized to one bit, a 3D-image of the one or more objects to be quantified, and/or calculating, from the normalized images, the fractal dimension of the overall image.

The present invention relates to a method and an apparatus for processing images of irregularly shaped objects, such as biological tissues and items, in particular of human or animal origin. The metric quantification of a biological body part or tissue or of a material spot or aggregate of any origin which is contained therein is also performed by means of the invention method. In particular, the method of the present invention is applied to the “confocal microscopy” technique.

The Laser Scanning Confocal Microscopy (LSCM) is a known technique used for obtaining high resolution images and 3D-images of biological specimens. LSCM is based on a laser light beam which is focused on a point or a small spot of a fluorescent specimen by means of an objective lens. The laser beam is made to scan the specimen through a x-y deflection mechanism. Both the reflected and the emitted fluorescent light are focused onto a photomultiplier via a dicroic mirror. The dicroic mirror lets the fluorescent light to pass toward the photomultiplier, through a confocal aperture (pinhole). The out-of-focus light, coming from points that are not within the focal plane of the observed specimen, is stopped by the pinhole, while the focal plane information is recorded as a digital image. The intensity of the fluorescent light corresponds to a pixel intensity (normally, as a 8-bit grey scale). By moving the microscope stage up and down, scanning in the z direction is effected, which allows for a 3D-reconstruction of the observed item. The digital image is then processed by suitable image digital filters (contrast and brightness adjustement, noise removing, colour adding, etc.) and finally analysed.

Further improvements of the LSCM technique have brought to the Scanning Laser Ophtalmoscopy (SLO), which provides for a retinal imaging by direct observation of the patient's eye through a scanning laser confocal microscope wherein the optics of the eye have the same function of the objective lens.

Confocal scanning microscopes which make use of normal visible light instead of laser light are also known and are commonly used for corneal imaging.

The confocal ophtalmoscopy is a powerful tool for studying the living human eye and can give essential diagnostic information to the doctor.

Several drawbacks are however present in the known apparatuses. A first problem is that the objects to be observed within the image field (single cells or aggregates, etc.) often do not present the same brightness throughout the whole area of the image. This is mainly due to the position they occupy with respect to the image's centre, which has an higher brightness, or to the eye's section under examination, which may not wholly intecepts the object.

A further drawback concerns the way the acquired image is processed by the computer. It may be necessary, in some cases, to quantitatively evaluate physical and geometrical characteristics of the observed object, in order to achieve better diagnostic information. A typical example is the case of pharmacological trials regarding the corneal keratocytes and other components of the corneal stroma. In such a case, the known devices do not allow a correct quantification of the requested geometrical parameters to be made, particularly for highly irregularly shaped objects such as the ones named above, with the consequence that the outcome of the analysis may be incorrect or even misleading. There is therefore a need of improved methods and apparatuses that allow a correct quantification of the morphometric parameters of any item for which such quantification is requested.

The present invention addresses the above and other problems and solve them with a method and an apparatus as depicted in the attached claims.

Further characteristics and the advantages of the method and confocal microscopy apparatus for analyizing living eye' images according to the present invention will become clear from the following description of a preferred embodiment thereof, given by way of non-limiting example, with reference to the appended drawings, in which:

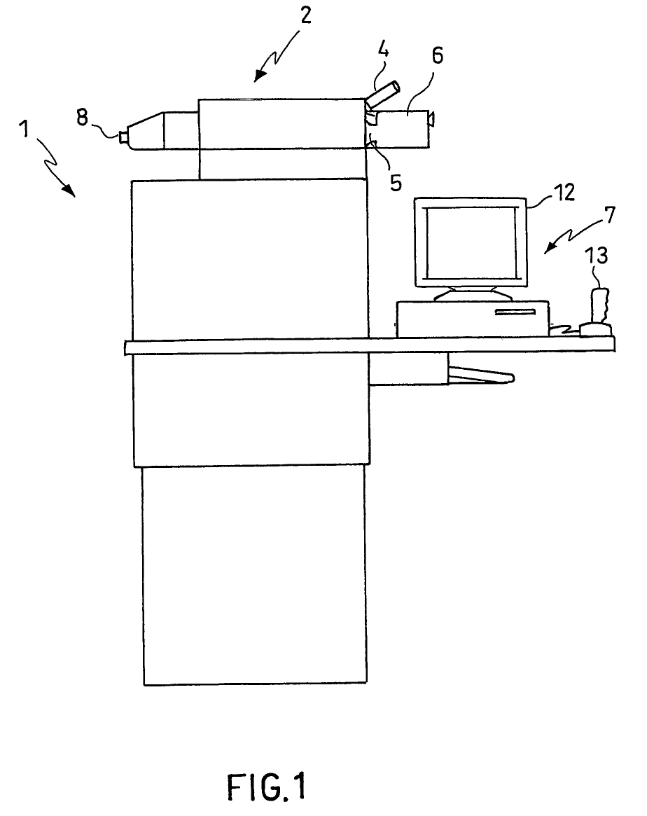

FIG. 1 is a schematic view of the apparatus according to the invention;

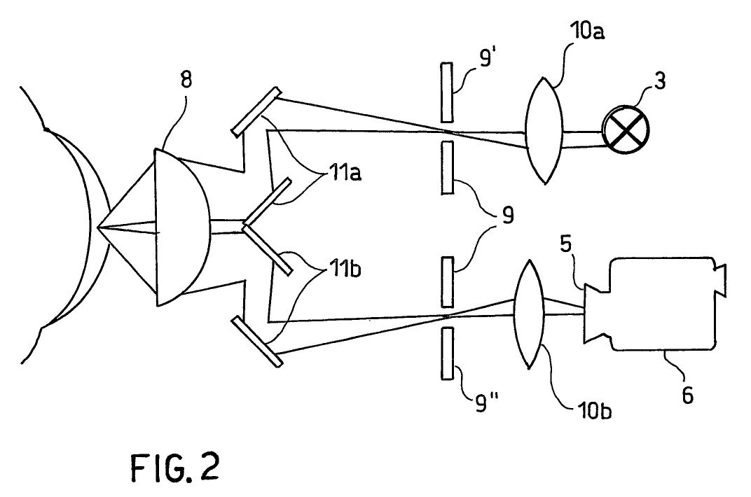

FIG. 2 is a schematic view of the optical assembly of the apparatus of FIG. 1;

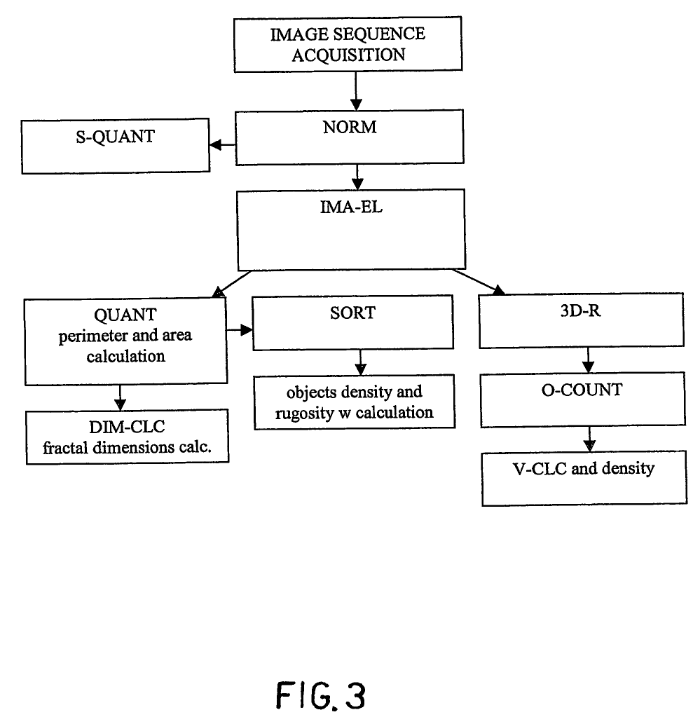

FIG. 3 is a flow chart illustrating the method of the invention.

The method of the invention allows one to analyse and metrically quantify an object's image, particularly the image of an object having irregular contour, whose Euclidean dimensions are not representative of the actual dimensions of the object. Even if the specific example shown herein below is concerned with the direct living eye's observation through a LSO technique, this kind of objects recur often when analyising a biological specimen.

With the term “biological specimens” it is herein intended any kind of biological sample taken from the human, animal or plant body (such as a tissue or cell sample) that can be analysed by means of Laser Scanning Confocal Microscopy or Laser Scanning Ophtalmoscopy apparatuses.

The example that will be described hereinafter concerns a system 1 for acquiring and processing an image comprising a confocal scanning microscope 2. The microscope 2 is preferably of the type that allow magnification from 50× up to 1000×.

The microscope 2 is provided with an object glass 8, at least one eyepiece 4 and at least one photo-video port 5 for camera attachment. To this latter, electronic image acquisition means 6, in particular a photo/video camera, are operatively connected. Preferably, such electronic image acquisition means 6 are a digital camera, having more preferably a resolution of at least 1.3 Megapixels.

The confocal scanning microscope 2 is equipped with a light source 3 which can be a halogen lamp or a laser beam source. Between the light source 3 and the photo-video port 5, along the light path, a slidable slit system 9 is located. A first slit 9′ is positioned between the light source 3 and the object glass 8, so that a slit-shaped light beam is projected onto the patient's cornea. Suitably, a first converging lens 10a is interposed between the light source and the first slit 9′, while a mirror system 11a directs the slit-shaped light beam to pass through a first half of the object glass 8.

The light reflected by the patient's cornea pass through the second half of the object glass 8 and then through a second slit 9″ to the photo-video port 5. Again, a mirror system 11b is suitably located in order to direct the reflected light collected by the object glass 8 to the second slit 9″ and a second converging lens 10b converges the collected light to the said photo-video port 5.

The slits 9′, 9″ are slidable in the x, y plane so that scanning of a cornea surface or section is effected. The object glass 8 is able to move along the z axis, in order to make a scanning along the depth of the cornea. This allows a 3D-image of the patient's cornea region to be acquired.

The electronic image acquisition means 6 are operatively connected with a processing system 7. The processing system 7 may be realized by means of a personal computer (PC) comprising a bus which interconnects a processing means, for example a central processing unit (CPU), to storing means, including, for example, a RAM working memory, a read-only memory (ROM)—which includes a basic program for starting the computer—, a magnetic hard disk, optionally a drive (DRV) for reading/writing opticasl disks (CD-RWs), optionally a drive for reading/writing floppy disks. Moreover, the processing system 7 optionally comprises a MODEM or other network means for controlling communication with a telematics network, a keyboard controller, a mouse controller and a video controller. A keyboard, a mouse and a monitor 12 are connected to the respective controllers. The electronic image acquisition means 6 are connected to the bus by means of an interface port (ITF). The slit system 9 and the object glass 8 are also connected to the bus by means of a control interface port (CITF) by which the movement of both the slit system and the object glass along the Cartesian axis is governed. A joystick 13 may also be provided in order to manually control the positioning of the object glass 8.

A program (PRG), which is loaded into the working memory during the execution stage, and a respective data base are stored on the hard disk. Typically, the program (PRG) is distributed on one or more optical disks CD-ROMs for the installation on the hard disk.

Similar considerations apply if the processing system 7 has a different structure, for example, if it is constituted by a central unit to which various terminals are connected, or by a telematic computer network (such as Internet, Intranet, VPN), if it has other units (such as a printer), etc. Alternatively, the program is supplied on floppy disk, is pre-loaded onto the hard disk, or is stored on any other substrate which can be read by a computer, is sent to a user's computer by means of the telematics network, is broadcast by radio or, more generally, is supplied in any form which can be loaded directly into the working memory of the user's computer.

Coming now to the description of the analysis procedure, the patient is positioned in front of the microscope 2, so that the patient's eye is aligned with the object glass 8. The object glass is spread with a drop of a suitable ophthalmic gel and is then caused to approach the patient's cornea up to a point that the eye is wetted by the gel but the glass does not contact it. At this point the scanning can be started until the whole acquisition procedure is terminated.

Once the images acquisition has been completed, the processing system 7 can perform the data elaboration routines according to the preferred embodiment of the invention, as will be depicted herein after.

It is pointed out that some or all of the steps of the method of the invention can be performed by the computer system 7 by executing the program PRG.

The method of the invention provides for the calculation of several parameters that can be of pivotal clinical significance.

In summary, the method of the invention is a method of processing digital images comprising one or more objects to be quantified, the said method comprising the following main stages:

normalization of the digital images;

quantization of the images to one bit, further comprising at least one of the following stages:

calculation from the said images quantized to one bit of the perimeter, area and/or fractal dimension of the said one or more objects to be quantified;

reconstruction from the said images quantized to one bit of a 3D-image of the said one or more objects to be quantified, and/or

calculation from the said normalized images of the fractal dimension of the overall image.

The stages which are part of the method of the invention will be now described in more details.

The first stage of the method of the invention is the stage of image normalization. Image normalization is a known procedure which is often applied to digital images. However, as said above, when the observed eye's section contains several objects to be analysed (cells and the like), these objects do not always present the same brightness throughout the image, the image's centre having an higher brightness than the contour. It has been found that the known normalization procedures utilizing parabolic functions do not serve the scope of the present invention, due to the described lack of uniformity of the brightness in the different image's areas. The inventors of the present application have therefore provided a new routine which is called progressive image normalization (NORM stage).

Before starting the image normalization routine it may be necessary to apply to the image a digital linear filter in order to remove the background noise. These filters are of the type conventionally used in image processing and can be used to remove isolated points. In the worse cases, a Gaussian filter can be used.

Once the image has been cleaned, if necessary, from the noise, the progressive image normalization can be started.

This stage is an iterative procedure which comprises the following steps:

1a) dividing the image into quadrants (typically, four quadrants);

2a) calculating the mean value of intensity of the pixels belonging to each quadrant;

3a) calculating the mean value of intensity for the quadrants as a mean of the calculated means of step 2a);

4a) setting for each quadrant the mean value of intensity calculated according to step 3a) by performing one of adding or subtracting a same intensity value to each pixel inside a quadrant in order to maintain the original Δ_{intensity} among the pixels inside a same quadrant;

5a) determining for each quadrant the max and the min values of intensity of the pixels and calculating for each pixel an extended intensity value (EI) which derives from the stretching of the digital values inside the range of the possible digital values. The range of the possible digital values is 0-256. Maximum stretching is obtained by an extension of the intensity values in the whole 0-256 range. However, intermediate extensions are possible. Preferably, the said EI value is calculated by means of the following algorithm:
EIₚᵢₓₑₗ=(Iₚᵢₓₑₗ−Iₘᵢₙ)×N/(Iₘₐₓ−Iₘᵢₙ)
wherein Iₚᵢₓₑₗ is the intensity of each pixel of a given quadrant, Iₘᵢₙ is the min value of intensity of the pixel inside the said quadrant, Iₘₐₓ is the max value of intensity of the pixel inside the same quadrant and N is an integer more than 1 and up to 255, preferably 255;

6a) setting for each pixel the EIₚᵢₓₑₗ calculated according to step 5a);

7a) reiterating steps 1a) to 6a) up to a preset quadrant side length.

The preset quadrant side length depends on the dimension of the objects to be detected and preferably will be approximately half length of the minor side of the object.

Step 5a) is also called as an extension of the pixels' intensity to a 0-255 scale and is helpful in order to improve the contrast inside the image. In some instances, steps 5a) and 6a) can be skipped.

According to a preferred embodiment of the invention, the normalization stage is performed according to the following procedure:

1b) dividing the image into quadrants (typically, four quadrants);

2b) determining for each quadrant the max and the min values of intensity of the pixels and calculating for each pixel an extended intensity value (EI) which derives from the stretching of the digital values inside the range of the possible digital values. As said before, the EI value can be calculated by means of the following algorithm:
EI=(Iₚᵢₓₑₗ−Iₘᵢₙ)×N/(Iₘₐₓ−Iₘᵢₙ)
wherein Iₚᵢₓₑₗ is the intensity of each pixel of a given quadrant, Iₘᵢₙ is the min value of intensity of the pixel inside the said quadrant, Iₘₐₓ is the max value of intensity of the pixel inside the same quadrant and N is an integer more than 1 and up to 255, preferably 255;

3b) storing the EIₚᵢₓₑₗ value for each pixel of each quadrant in a data structure;

4b) reiterating steps 1b) to 3b) up to a preset quadrant side length in order to obtain for each pixel a set of intensity values in the data structure;

5b) calculating for each pixel the mean of the intensity values of the set stored in the data structure and setting the calculated mean value to the respective pixel.

Again, the preset quadrant side length depends on the dimension of the objects to be detected and preferably will be approximately half length of the minor side of the object.

The routine depicted in steps 1b) to 5b) allows the processing system 7 to perform the whole calculation faster.

The second stage of the method of the invention is the stage of image elaboration (IMA-EL stage). This stage is performed by quantizing the image to “1 bit” in order to select image's regions on which further calculations are performed. The IMA-EL stage is accomplished according to the following steps:

1c) considering a parameter for each pixel;

2c) comparing said pixel's parameter with a preset threshold value or threshold range for said parameter;

3c) selecting a cluster of active pixels and a cluster of inactive pixels on the base of said comparison.

Said pixel's parameter is preferably brightness intensity (black and white images) or digital colour value. Said preset threshold value or range for said parameter will mainly depend upon the kind of object that should be detected. Selection of such threshold values or ranges can be made in any case by the skilled man, for the particular case, without excercize of any inventive skill. For example, if the object whose image has to be acquired is the corneal stroma (B & W image) the range of intensity values is 128-255.

Once the digital image has been quantized to 1 bit, the method of the invention provides for a stage of metrical processing of the image which is made on its turn of different stages that will be depicted herein below.

The next stage of the invention method is thus the stage of object's metrical quantification (QUANT stage).

This stage has been set up for improving metrical quantification of the morphometric parameters of irregularly shaped objects, that can not be metered by the usual Euclidean geometry. The microscopic observation of either a normal or abnormal, such as pathological, component of a given organ, particularly an eye, is amazing because of the new irregularities that appear at any magnification (scale of observation). As the extension form of the image of the samples changes, the new irregular details are given measures and dimensions that are independent at each magnification and can not be arranged in a single linear system. Because of this characteristic, which is due to the scabrousness of the external surface of the object to be observed, the visible details, as well as those that can not be visually identified, make all objects with an irregular surface hardly measurable by means of traditional computer-aided morphometry.

The classical morphometry tackles the problem of measuring natural objects by approximating their irregular outlines and rough surfaces to rectilinear outlines and plane surfaces.

Irregular objects were defined “fractal” by Benoit Mandelbrot since, in spite of the fact that their shape changes as a function of magnification, they retain the features of their irregularity at all spatial scales. Although the pieces (not fractions) into which they can be divided are not equal, they preserve the similitude of their irregularity. This property of the parts into which irregular objects can be divided is called “self-similarity”. Since the shape of such objects depends on the magnification at which their image is observed, any quantitative metering of the dimensions of the object is a function of the magnification scale. The fractal dimension indicates therefore the “self-similarity” of the fractal pieces of an irregular body and, at each scale, defines the characteristics of the reference means used to measure the physical and geometrical parameters of the observed irregular object.

The first step of the QUANT stage is the calculation of the area of the object under examination. The unit of measurement may be μm² or pixel.

The area A of the object under examination is thus calculated by counting the number of pixels belonging to the cluster of active pixels selected according to the previous IMA-EL stage.

The second step of the QUANT stage is the calculation of the perimeter P of the object under investigation. This step is performed by i) selecting the object contour's pixels, and ii) applying to such selected pixels the perimeter calculation's algorithm according to S. Prashker method (Steve Prashker, An Improved Algorithm for Calculating the Perimeter and Area of Raster Polygons, GeoComputation, 1999, which is herein incorporated by reference). According to the Prashker's method, each active pixel's surroundings are taken into consideration, i.e. the eight pixels around the pixel under examination. To each active pixel is given a “perimeter value”, whose sum is the overall perimeter P of the object. If, for example, an internal pixel is considered (i.e. a pixel totally surrounded by active pixels, thus not belonging to the perimeter of the object), to such a pixel is given a “perimeter value” of 0. If a perimeter's pixel is connected with two other pixels through the corners along a diagonal line, the “perimeter value” is \sqrt{2} pixels. If the considered active pixel is connected to one pixel through the corner and to another pixel by a side, the “perimeter value” will be (0.5+\sqrt{2}/2) pixels. If an active pixel is connected to the two adjacent pixels through its sides, the “perimeter value” will be then 1 pixel and so on.

Given the considerable irregularity of the perimeter of the object under examination, an evaluation of its fractal dimension D_{P} is made. Similarly, the estimate of the fractal dimension of the area of the selected structure is indicated by the symbol D_{A}. Both of these fractal dimensions can be automatically determined using the known “box-counting” algorithm.

According to the “box-counting” method, the fractal dimension D is given by the mathematical formula
D=lim(ε−>0)[log N(ε)/log (1/ε)]
wherein ε is the length of the side of the boxes of the grid in which the object's image has been divided and N(ε) is the number of boxes necessary to completely cover the outline (D_{P}) or the area (D_{A}), respectively, of the measured object. The length ε is expressed in pixel or μm and, in the present calculation method, ε tends to 1 pixel.

The next stage of the invention method is thus the stage of dimensional calculation (DIM-CLC stage).

In order to avoid difficulties in such a calculation, the fractal dimensions D_{P} and D_{A} are approximated as the slope of the straight line obtained by putting in a Cartesian axis system the parameters log N(ε) versus log(1/ε).

In practice, the method used to determine D_{P} comprises the following steps, performed by the CPU of the processing system 7:

a) dividing the image of the object into a plurality of grids of boxes having a side length ε, in which ε varies from a first value substantially corresponding to the side of the box in which said object is inscribed and a predefined value which is a fraction of said first value,

b) calculating a value of a logarithmic function of N(ε), in which N(ε) is the number of boxes necessary to completely cover the perimeter (P) of the object and of a logarithmic function of 1/ε for each ε value of step a), thus obtaining a first set of values for said logarithmic function of N(ε) and a second set of values for said logarithmic function of 1/ε,

c) calculating the fractal dimension D_{P} as the slope of the straight line interpolating said first set of values versus said second set of values of step b).

The same method is applied for calculating the fractal dimension D_{A}, with the only difference that, in this case, N(ε) is the number of boxes of side ε that completely cover the area of the object to be quantified.

The fractal dimensions D_{P} and D_{A} of the single objects are a numerical index of the irregularity of the object itself, i.e. whether the object is more or less irregularly shaped. This can give a useful indication to the clinician about the pathological condition of the patient.

Since an ocular image of the stroma evidences a multiplicity of small objects (cells) which give an indication of the pathological degree of the patient, it is important for a metrical analysis of the stroma to identify all the objects observed through the ophtalmoscope. A further stage of the method of the invention is therefore the stage of object's sorting (SORT stage) which includes the following steps:

1d) scanning of the image quantized to “1 bit” along a predefined direction on a x, y axis system;

2d) selecting a first active pixel along said direction of scanning, said active pixel being identified by a first set of x, y values, said first active pixel belonging to a first object's image;

3d) performing on said first selected active pixel a search routine in the positions next to said selected pixel on the direction's line;

4d) iterating step 3d) until an inactive pixel is found;

5d) assigning to each active pixel selected according to such steps 3d) and 4d) a set of x, y values, saving them in the storing means of the processing system 7 (all of such pixels will have the same y value and x values in progressive order) and switching said pixels from active to inactive in the object's image;

6d) evaluating for each pixel selected according to steps 3d), 4d) and 5d) the two next pixels in the direction ortogonal to the said scanning direction and selecting the active pixels;

7d) performing, for each of said active pixels selected according to step 6d), the routine of steps 3d) to 5d);

8d) iterating steps 6d) and 7d) until all of the connected pixels belonging to the same object have been saved;

9d) repeating steps 1d) and 2d) until a first active pixel of a further object's image is found;

10d) repeating steps 3d) to 9d) until the whole image has been scanned.

Said predefined direction in step 1d) is preferably from left to right starting from top to bottom.

The procedure depicted in steps 1d) to 10d) above allows to identify objects made up from 4-connected pixels, i.e. wherein the pixels have one side in common.

For sorting also 8-connected pixel objects, step 6d) of the above procedure is modified as follows:

6d) evaluating for each pixel selected according to steps 3d), 4d) and 5d) the two next pixels in the direction ortogonal to the said scanning direction and the two pixels adjacent, to each of these latter pixels on the parallel line adjacent to the direction's line and selecting the active pixels.

The procedure is then prosecuted according to steps 7d) to 10d).

The procedure herein above depicted is a semi-recursive method which allows, with respect to the standard recursive methods of the art, shorter execution time and less memory request. In fact, taking into consideration an image made up of N×M active pixels, only M recursive calls are necessary, while according to the prior art methods the number of recursive calls would be N×M −1.

After the SORT stage, the method of the invention may perform the following steps:

1e) calculating the area of each object identified according to the SORT stage by counting the number of pixels belonging to said object's image and multiplying it for the area of each pixel;

2e) counting the number of objects and calculating its density;

3e) calculating the mean area of the objects by adding the areas calculated according to step 1e) of all the objects sorted and dividing the total area by the number of objects obtained according to step 2e).

The method of the invention also allows the calculation of a parameter known as “rugosity” which gives an indication of the uneveness of the surface of the object to be quantified (typically, a cell structure). The parameter w indicating the degree of “rugosity” of the selected object can be calculated by means of the following algorithm:
w=Pf/2\sqrt{Afπ}−R (III)
wherein Pf is the perimeter, Af is the area of the object and R is the “roundness coefficient” of the object. R is on its turn calculated with the following algorithm
R=Pe/2\sqrt{Aeπ} (IV)
wherein Pe is the perimeter of the ellipse in which the measured object is inscribed and Ae its area.

A further stage of the method of the invention is the stage of surface quantification (S-QUANT stage).

This stage provides for a metrical evaluation of the “surface” of the whole image. This helps achieving a better picture of the distribution and shape of the various single objects (cells and the like) inside the cornea and thus improving the diagnostic outcome.

The base concept is that the image can be seen as a tridimensional surface. The grey scale values of the pixels in the image are an index of how much the observed object extends along the axis orthogonal to the image (z axis). In other words, the digital image appears as a “hill cluster” whose surface dimension can be calculated as a fractsl dimension. For these reasons, the S-QUANT stage is performed on the image normalized according to the routine described above, but before the said IMA-EL stage.

In this case too the fractal dimension of the surface can be calculated by using the “box counting” methodology, which is however adapted for set of values x, y, z, i.e. in the three dimensions.

The S-QUANT stage comprises the following steps:

1f) dividing the image in a x, y bidimensional mesh with n×n boxes of side l;

2f) dividing the 0-256 grey scale into n subregions having each a 256/n value;

3f) calculating for each box of the x, y bidimensioanl mesh the min and max value of the pixels contained therein and of the pixels that contour the box;

4f) calculating how many subregions of 256/n value are included between the min and max values of the pixels of each box;

5f) calculating the number N(l) of tridimensional boxes of side l that intercepts the image's surface as a sum of the subregions of all the boxes calculated according to step 4f);

6f) reiterating steps 1f) to 5f) with a side length l′ less than l;

7f) by repeating step 6f), generating a first set of values of a logarithmic function of 1/l and a second set of values of a logarithmic function of N(l);

8f) calculating the fractal dimension of the image's surface as the slope of the straight line interpolating said first set of values versus said second set of values of step 7f).

The calculation of the fractal dimension of the surface provides a numerical index of the image's complexity, i.e. the distribution of the cells in the observed tissue, which can be correlated with the pathological condition of the patient.

As said before, the LSO technique provides for a 3D-reconstruction of the image which is made possible by the scanning in the z direction of the observed item. In the present specific example, a picture of several sections of the observed cornea is taken and the several acquired 2D-images are reconstructed to form a tridimensional image. The so reconstructed 3D-image is helpful in order to have an overall picture of the observed tissue and thus to identify type, number and density of the cells that are contained therein.

Therefore, the method of the present invention also comprises the volume analysis.

The first stage of the volume analysis is the stage of 3D-reconstruction (3D-R stage). This stage is performed on the image once it has been subjected to the IMA-EL stage.

According to the invention procedure, the 3D-image is obtained by overlapping the 2D-images collected for each section of the examined tissue. However, due to even minor movements of the observed eye during the analysis performance, there can be some misalignement between one 2D-image and the subsequent 2D-image in the direction of scanning. The method of the invention thus provides for an adjustement of the offset between the overlapped images.

The 3D-R stage comprises the following steps:

1g) overlapping each image with the subsequent image along the z axis;

2g) minimizing the difference of brightness and/or colour intensity between overlapping pixels by shifting along the x axis and/or the y axis an image with respect to each other;

3g) repeating steps 1g) and 2g) for each pair of adjacent images.

After the 3D-image has been reconstructed, it is possible to proceed with the counting of the number of items (typically cells) that are contained in the observed tissue, as well as with the calculation of their density. These parameters too are of utmost importance to achieve meaningful diagnosis results.

Counting of the cells is performed by means of the object counting stage (O-COUNT stage), which comprises the following steps:

1h) scanning of the 3D-image quantized to “1 bit” along a predefined direction on a x, y axis system;

2h) selecting a first active pixel along said direction of scanning, said active pixel being identified by a first set of x, y values, said first active pixel belonging to a first object's image;

3h) performing on said first selected active pixel a search routine in the positions next to said selected pixel on the direction's line;

4h) iterating step 3h) until an inactive pixel is found;

5h) assigning to each active pixel selected according to such steps 3h) and 4h) a set of x, y values, saving them in the storing means of the processing system 7 (all of such pixels will have the same y value and x values in progressive order) and switching said pixels from active to inactive in the object's image;

6h) evaluating for each pixel selected according to steps 3h), 4h) and 5h) the two next pixels in the coplanar direction orthogonal to the said scanning direction and the two next pixels along the z axis, in the directions +z and −z, and selecting the active pixels;

7h) performing, for each of said active pixels selected according to step 6h), the routine of steps 3h) to 5h);

8h) iterating steps 6h) and 7h) until all of the connected pixels belonging to the same object have been saved;

9h) repeating steps 1h) and 2h) until a first active pixel of a further object's image is found;

10h) repeating steps 3h) to 9h) until the whole image has been scanned;

11h) counting of the number of the objects sorted according to steps 1h) to 10h).

Said predefined direction in step 1h) is preferably from left to right starting from top to bottom.

The search of the active pixels in the directions +z and −z is performed by overlapping the images in sequence.

The procedure depicted in steps 1h) to 10h) above allows to identify objects made up from 4-connected pixels, i.e. wherein the pixels have one side in common.

For sorting also 8-connected pixel objects, step 6h) of the above procedure is modified as follows:

6h) evaluating for each pixel selected according to steps 3h), 4h) and 5h) the two next pixels in the coplanar direction orthogonal to the said scanning direction and the two next pixels along the z axis, in the directions +z and −z, and the two pixels adjacent to each of these pixels on the parallel line adjacent to the direction's line and selecting the active pixels.

The procedure is then prosecuted according to steps 7h) to 10h).

The procedure herein above depicted is a semi-recursive method which allows, with respect to the standard recursive methods of the art, shorter execution time and less memory request.

Once the number of objects, namely cells, contained in the examined tissue has been determined according to the above procedure, the objects' density is easily determined as the total number of objects over the whole 3D-image volume:
d=N_{objects}/V_{image}

wherein the image's volume is calculated as the number of sections multiplied for the interval thickness among the sections, multiplied for the extension (area) of the section.

The next stage of the method of the invention is the stage of volume calculation (V-CLC stage). According to this stage the volume of the objects contained in the examined tissue is determined.

The V-CLC stage comprises the following steps:

1i) calculating the area of each object in a first 2D-image corresponding to a first object's section;

2i) multiplying the area calculated according to step 1i) for the distance between the said first section's image and the subsequent section's image, taken in the z direction of scanning, wherein an image of the same object is contained;

3i) reiterating steps 1i) and 2i) for each section's image in the order.

The overall volume of the objects in the examined tissue is determined as the sum of the single volumes calculated according to the above procedure.

The area calculation according to step 1i) is preferably made by counting the number of active pixels belonging to the same object and then multiplying for the area of the pixel. The object is identified as depicted in the O-COUNT stage, so that each object is given a set of x, y and z values.

The distance between each section's image and the subsequent one is a known parameter in the confocal microscopy technique.

The above volume was calculated by approximating the objects' volume to that of a substantially cylindrical solid. However, by approximating it to a frustum of cone, the volume being calculated as:
v=1/3d(A+a+\sqrt{A.a})

wherein d is the known distance between the two sections, A is the area of the first object's section and a is the area of the second object's section.

The mean volume of the objects is finally given by dividing the overall volume for the number of objects as calculated before.

From what has been said above, it is clear that the calculation method of the invention represents an improvement if compared with the known methods. The fractal geometry offers mathematical models derived from the infinitesimal calculus that, when applied to Euclidean geometry, integrate the figures of the morphometrical measurements of natural and irregular objects, thus making them closer to the actual values. Dimensional calculation using the fractal geometry gives numerical indexes (fractal dimensions) for both the single objects (index of the space distribution of the object's area/volume) and the image as a whole (index of the space distribution of the objects in the observed tissue). This allows the clinician to compare numerical values of the patient with standardised values, thus arriving immediately and with repeatable accuracy to the diagnosis of the pathological condition of the patient. This is believed to be a dramatic improvement on the prior art diagnostic methods, wherein only a visual and qualitative analysis of the patient's eye image was available in order to make the diagnosis.

Naturally, only some specific embodiments of the method and apparatus for analyizing biological tissue specimens according to the present invention have been described and a person skilled in the art will be able to apply any modification necessary to adapt it to particular applications without, however, departing from the scope of protection of the present invention.

1. Method of processing digital images comprising one or more objects to be quantified, the said method comprising the following main stages:
normalization of the digital images;
quantization of the images to one bit, further comprising at least one of the following stages:
calculating, from the said images quantized to one bit, the perimeter, area and/or fractal dimension of the said one or more objects to be quantified;
reconstructing, from the said images quantized to one bit, a 3D-image of the said one or more objects to be quantified, and/or
calculating, from the said normalized images, the fractal dimension of the overall image.

2. Method according to claim 1, the said method comprising a stage of image's normalization (NORM) which comprises the following steps:
1) dividing the image into quadrants;
2) calculating the mean value of intensity of the pixels belonging to each quadrant;
3) calculating the mean value of intensity for all the quadrants as a mean of the calculated means of step 2);
4) setting for each quadrant the mean value of intensity calculated according to step 3) by performing one of adding or subtracting a same intensity value to each pixel inside a quadrant in order to maintain the original Δ_{intensity} among the pixels inside a same quadrant;
5) reiterating steps 1) to 4) up to a preset quadrant side length.

3. Method according to claim 2, wherein the said preset quadrant side length is approximately half length of the minor side of the said one or more objects to be quantified.

4. Method according to any one of claims from 1 to 3, wherein the said digital image has been acquired by a confocal microscopy.

5. Method according to claim 4, wherein the said confocal microscopy is a Laser Scanning Confocal Microscopy (LSCM) or a Scanning Ophtalmoscopy.

6. Method according to any one of claims from 1 to 5, which comprises the following steps:
1a) dividing the image into four quadrants;
2a) calculating the mean value of intensity of the pixels belonging to each quadrant;
3a) calculating the mean value of intensity for the four quadrants as a mean of the four calculated means of step 2a);
4a) setting for each quadrant the mean value of intensity calculated according to step 3a) by performing one of adding or subtracting a same intensity value to each pixel inside a quadrant in order to maintain the original Δ_{intensity} among the pixels inside a same quadrant;
5a) determining for each quadrant the max and the min values of intensity of the pixels and calculating for each pixel an extended intensity value (EI) which derives from the stretching of the digital values inside the range of the possible digital values;
6a) setting for each pixel the EIₚᵢₓₑₗ calculated according to step 5a);
7a) reiterating steps 1a) to 6a) up to a preset quadrant side length.

7. Method according to claim 6, wherein the said step 5a) of calculating the EI value of the pixels is performed by means of the following algorithm:
EIₚᵢₓₑₗ=(Iₚᵢₓₑₗ−Iₘᵢₙ)×N/(Iₘₐₓ−Iₘᵢₙ)
wherein Iₚᵢₓₑₗ is the intensity of each pixel of a given quadrant, Iₘᵢₙ is the min value of intensity of the pixel inside the said quadrant, Iₘₐₓ is the max value of intensity of the pixel inside the same quadrant and N is an integer more than 1 and up to 255, preferably 255.

8. Method according to any one of claims from 1 to 5, wherein the said normalization stage comprises:
1b) dividing the image into quadrants;
2b) determining for each quadrant the max and the min values of intensity of the pixels and calculating for each pixel an extended intensity value (EI) which derives from the stretching of the digital values inside the range of the possible digital values;
3b) storing the EIₚᵢₓₑₗ value for each pixel of each quadrant in a data structure;
4b) reiterating steps 1b) to 3b) up to a preset quadrant side length in order to obtain for each pixel a set of intensity values in the data structure;
5b) calculating for each pixel the mean of the intensity values of the set stored in the data structure and setting the calculated mean value to the respective pixel.

9. Method according to claim 8, wherein the said step 5a) of calculating the EI value of the pixels is performed by means of the following algorithm:
EIₚᵢₓₑₗ=(Iₚᵢₓₑₗ−Iₘᵢₙ)×N/(Iₘₐₓ−Iₘᵢₙ)
wherein Iₚᵢₓₑₗ is the intensity of each pixel of a given quadrant, Iₘᵢₙ is the min value of intensity of the pixel inside the said quadrant, Iₘₐₓ is the max value of intensity of the pixel inside the same quadrant and N is an integer more than 1 and up to 255, preferably 255.

10. Method according to any one of claims from 1 to 9, further comprising a stage of image elaboration (IMA-EL stage) to quantize the image to “1 bit”.

11. Method according claim 10, wherein the said IMA-EL stage comprises the following steps:
1c) considering a parameter for each pixel;
2c) comparing said pixel's parameter with a preset threshold value or threshold range for said parameter;
3c) selecting a cluster of active pixels and a cluster of inactive pixels on the base of said comparison,
wherein said pixel's parameter is preferably brightness intensity (black and white images) or digital colour value.

12. Method according to any one of claims from 1 to 11, further comprising a stage of image quantification which comprising at least one of the following steps:
calculating the area A of the object under examination by counting the number of pixels belonging to the cluster of active pixels selected according to the previous IMA-EL stage;
calculating the perimeter P of the object under examination by i) selecting the object contour's pixels, and ii) applying to such selected pixels a perimeter calculation's algorithm, wherein to each active pixel belonging to the object is given a “perimeter value”, which is a function of the position of the active pixels adjacent to the pixel under examination, the sum of said “perimeter values” being the overall perimeter P of the object.

13. Method according to any one of claims from 1 to 12, further comprising a stage of object's sorting (SORT) for identifying objects made up from 4-connected pixels, which includes the following steps:
1d) scanning of the image quantized to “1 bit” along a predefined direction on a x, y axis system;
2d) selecting a first active pixel along said direction of scanning, said active pixel being identified by a first set of x, y values, said first active pixel belonging to a first object's image;
3d) performing on said first selected active pixel a search routine in the positions next to said selected pixel on the direction's line;
4d) iterating step 3d) until an inactive pixel is found;
5d) assigning to each active pixel selected according to such steps 3d) and 4d) a set of x, y values, saving them in the storing means of the processing system (7) and switching said pixels from active to inactive in the object's image;
6d) evaluating for each pixel selected according to steps 3d), 4d) and 5d) the two next pixels in the direction orthogonal to the said scanning direction and selecting the active pixels;
7d) performing, for each of said active pixels selected according to step 6d), the routine of steps 3d) to 5d);
8d) iterating steps 6d) and 7d) until all of the connected pixels belonging to the same object have been saved;
9d) repeating steps 1d) and 2d) until a first active pixel of a further object's image is found;
10d) repeating steps 3d) to 9d) until the whole image has been scanned.

14. Method according to claim 13, wherein said predefined direction in step 1d) is from left to right starting from top to bottom.

15. Method according to claim 13 or claim 14, wherein the stage of object's sorting according to steps 1d) to 10d) is performed for also identifying objects made up from 8-connected pixels, in said stage the step 6d) being modified as follows:
6d) evaluating for each pixel selected according to steps 3d), 4d) and 5d) the two next pixels in the direction orthogonal to the said scanning direction and the two pixels adjacent to each of these latter pixels on the parallel line adjacent to the direction's line and selecting the active pixels.

16. Method according to any one of claims from 13 to 15, further comprising at least one of the following steps:
1e) calculating the area of each object identified according to the SORT stage by counting the number of pixels belonging to said object's image and multiplying it for the area of each pixel; and/or
2e) counting the number of objects and calculating its density; and/or
3e) calculating the mean area of the objects by adding the areas calculated according to step 1e) of all the objects sorted and dividing the total area by the number of objects obtained according to step 2e).

17. Method according to any one of claims from 1 to 16, further comprising a step of calculating a parameter (w) indicating the degree of “rugosity” of the selected object, the said (w) parameter being preferably calculated by means of the following algorithm:
w=Pf/2\sqrt{Af π}−R
wherein Pf is the perimeter, Af is the area of the object and R is the “roundness coefficient” of the object; wherein R is on its turn calculated with the following algorithm
R=Pe/2\sqrt{Aeπ}
wherein Pe is the perimeter of the ellipse in which the measured object is inscribed and Ae its area.

18. Method according to any one of claims from 1 to 17, further comprising a stage of dimensional calculation (DIM-CLC) for calculating the fractal dimensions of perimeter and area of the observed objects, wherein said fractal dimension of the perimeter (D_{P}) and said fractal dimension of the area (D_{A}) are determined according to the following steps:
a) dividing the image of the object into a plurality of grids of boxes having a side length ε, in which ε varies from a first value substantially corresponding to the side of the box in which said object is inscribed and a predefined value which is a fraction of said first value,
b) calculating a value of a logarithmic function of N(ε), in which N(ε) is the number of boxes necessary to completely cover the perimeter (P) or the area (A), respectively, of the object and of a logarithmic function of 1/ε for each a value of step a), thus obtaining a first set of values for said logarithmic function of N(ε) and a second set of values for said logarithmic function of 1/ε,
c) calculating the fractal dimensions (D_{P}) or (D_{A}) as the slope of the straight line interpolating said first set of values for said logarithmic function of N(ε) for the perimeter (P) or the area (A), respectively, versus said second set of values of step b).

19. Method according to any one of claims from 1 to 18, further comprising a stage of surface quantification (S-QUANT) performed on the image normalized according to the NORM stage, the said stage comprising the following steps:
1f) dividing the image in a x, y bidimensional mesh with n×n boxes of side l;
2f) dividing the 0-256 grey scale into n subregions having each a 256/n value;
3f) calculating for each box of the x, y bidimensioanl mesh the min and max value of the pixels contained therein and of the pixels that contour the box;
4f) calculating how many subregions of 256/n value are included between the min and max values of the pixels of each box;
5f) calculating the number N(l) of tridimensional boxes of side l that intercepts the image's surface as a sum of the subregions of all the boxes calculated according to step 4f);
6f) reiterating steps 1f) to 5f) with a side length l′ less than l;
7f) by repeating step 6f), generating a first set of values of a logarithmic function of 1/l and a second set of values of a logarithmic function of N(l);
8f) calculating the fractal dimension of the image's surface as the slope of the straight line interpolating said first set of values versus said second set of values of step 7f).

20. Method according to any one of claims from 1 to 19, further comprising a stage of 3D-reconstruction (3D-R) performed on the image subjected to the IMA-EL stage, the said 3D-R stage comprising the following steps:
1g) overlapping each image with the subsequent image along the z axis;
2g) minimizing the difference of brightness and/or colour intensity between overlapping pixels by shifting along the x axis and/or the y axis an image with respect to each other;
3g) repeating steps 1g) and 2g) for each pair of adjacent images.

21. Method according to claim 20, further comprising a stage of object counting (O-COUNT), which comprises the following steps:
1h) scanning of the 3D-image quantized to “1 bit” along a predefined direction on a x, y axis system;
2h) selecting a first active pixel along said direction of scanning, said active pixel being identified by a first set of x, y values, said first active pixel belonging to a first object's image;
3h) performing on said first selected active pixel a search routine in the positions next to said selected pixel on the direction's line;
4h) iterating step 3h) until an inactive pixel is found;
5h) assigning to each active pixel selected according to such steps 3h) and 4h) a set of x, y values, saving them in the storing means of the processing system 7 (all of such pixels will have the same y value and x values in progressive order) and switching said pixels from active to inactive in the object's image;
6h) evaluating for each pixel selected according to steps 3h), 4h) and 5h) the two next pixels in the coplanar direction orthogonal to the said scanning direction and the two next pixels along the z axis, in the directions +z and −z, and selecting the active pixels;
7h) performing, for each of said active pixels selected according to step 6h), the routine of steps 3h) to 5h);
8h) iterating steps 6h) and 7h) until all of the connected pixels belonging to the same object have been saved;
9h) repeating steps 1h) and 2h) until a first active pixel of a further object's image is found;
10h) repeating steps 3h) to 9h) until the whole image has been scanned;
11h) counting of the number of the objects sorted according to steps 1h) to 10h).

22. Method according to claim 21, wherein the said predefined direction in step 1h) is from left to right starting from top to bottom.

23. Method according to claim 21 or claim 22, for sorting also 8-connected pixel objects, wherein step 6h) of the procedure depicted in claim 21 is modified as follows:
6h) evaluating for each pixel selected according to steps 3h), 4h) and 5h) the two next pixels in the coplanar direction orthogonal to the said scanning direction and the two next pixels along the z axis, in the directions +z and −z, and the two pixels adjacent to each of these pixels on the parallel line adjacent to the direction's line and selecting the active pixels.

24. Method according to any one of claims from 1 to 23, further comprising a stage of volume calculation (V-CLC) which comprises the following steps:
1i) calculating the area of each object in a first 2D-image corresponding to a first object's section;
2i) multiplying the area calculated according to step 1i) for the distance between the said first section's image and the subsequent section's image, taken in the z direction of scanning, wherein an image of the same object is contained;
3i) reiterating steps 1i) and 2i) for each section's image in the order.

25. Method according to claim 24, wherein the overall volume of the objects in the examined tissue is determined as the sum of the single volumes.

26. Method according to claim 24 or claim 25, wherein the volume is calculated as:
v=1/3d(A+a+\sqrt{A.a})
wherein d is the distance between the two sections, A is the area of the first object's section and a is the area of the second object's section.

27. A system (1) for acquiring and processing an image including a confocal scanning microscope (2), electronic image acquisition means (6) operatively connected to said microscope (2), a processing system (7) operatively connected with said confocal scaning microscope (2) and said image acquisition means (6), said processing system (7) comprising a processing unit (CPU), storing means which include a RAM working memory and a hard disk, said processing system (7) running a program (PRG) to perform a method according to any one of claims from 1 to 26.

28. A software program (PRG) to perform the method according to any one of claims from 1 to 26.

29. A computer readable support comprising a program (PRG) to perform the method according to any one of claims from 1 to 26.

30. Use of a system (1) according to claim 27 or claim 28, for performing a method as depicted in any one of claims from 1 to 26.
